(19) United States
(12) Patent Application Publication
(10) Pub. No.: US 2026/0041611 A1
(43) Pub. Date: Feb. 12, 2026

(54) Method of Ingesting a Medicinal Pill

(71) Applicant: Tsungda Hsu, Lenox, MA (US)

(72) Inventor: Tsungda Hsu, Lenox, MA (US)

(21) Appl. No.: 18/800,036

(22) Filed: Aug. 10, 2024

(51) Int. Cl. A61J 7/00

(52) U.S. Cl. CPC A61J 7/0015

(57) ABSTRACT

A method for ingesting a medicinal pill by mouth. The method comprises having a beverage comprising an aqueous liquid and a gas dissolved in the aqueous liquid. A pill is placed on the tongue. The beverage is poured into the mouth, wherein the beverage generates gas bubbles. The gas bubbles lift the pill off the tongue. The subject then swallows the beverage together with the pill.

### TECHNICAL FIELD

This invention relates to techniques for swallowing a medicinal pill.

### BACKGROUND

Oral drug administration is a widely established method for delivering therapeutic agents to patients. Conventional methods typically involve swallowing a pill, followed by ingestion of water to facilitate swallowing. While effective for many medications, traditional pill ingestion methods present challenges for some people, such as the elderly, young children, and people with swallowing difficulties (dysphagia). In some children, inability to swallow medicinal pills may cause psychological trauma from the fear of gagging, choking, or vomiting. For many children, the ability to swallow medicinal pills requires training and practice.

Additionally, large pill size or unpleasant taste can hinder swallowing and reduce patient compliance. Thus, there is a need for improved methods of pill ingestion that enhance comfort and compliance, particularly for people with swallowing difficulties or aversion to ingesting pills.

### SUMMARY

This invention is for a method of ingesting a medicinal pill by mouth. This method uses a beverage comprising an aqueous liquid and a gas dissolved in the aqueous liquid. The pill is placed on the tongue in the mouth. The beverage is poured into the mouth. Inside the mouth, the beverage generates gas bubbles. The beverage is retained in the mouth until the gas bubbles lift the pill off the tongue. The subject swallows the beverage together with the pill.

### BRIEF DESCRIPTION OF THE DRAWINGS

FIG. 1 shows the inside of a subject's mouth with a pill placed on the subject's tongue.

FIG. 2 shows the inside of the subject's mouth after some beverage is poured into the subjects mouth.

FIG. 3 shows the beverage and pill being swallowed.

### DETAILED DESCRIPTION

Drawings are provided to help understand the invention and illustrate specific representative examples. The drawings herein are not necessarily made to scale or actual proportions. For example, the size of components may be adjusted to accommodate the page size.

This method of ingesting a pill uses a gas-containing beverage (e.g. a carbonated beverage) to facilitate swallowing of the pill. The beverage comprises an aqueous liquid and a gas dissolved therein. The gas is pressurized and the beverage is stored in a sealed container (e.g. can or bottle) to hold the pressurized contents. Any suitable gas could be used. Examples of gases that could be used include O₂, CO₂, N₂, H₂, He, air, etc. The beverage may further comprise other conventional ingredients such as sweeteners, flavorings, dyes, preservatives, etc. The beverage may be stored at a cold temperature. For example, the beverage may be stored at a temperature in the range of 0-10° C.

When the beverage is poured into the subject's mouth, gas bubbles form within the beverage. The amount and size of the bubbles (e.g. small, medium, large) may vary depending on manufacturing parameters such as the type of gas infused into the aqueous liquid, the amount of gas infused into the aqueous liquid, the pressurization of the beverage inside the sealed container, the temperature at which the gas is infused into the aqueous liquid, etc.

The source of the bubbles is the gas dissolved in the aqueous liquid. The amount of gas that can be dissolved in the water (i.e. solubility) is governed by Henry's Law. This law states that at a constant temperature, the solubility of a gas in water is directly proportional to the surface partial pressure of the gas. The higher the surface partial pressure of the gas, the more of the gas can be dissolved in water. In addition, the lower the temperature, the more of the gas can be dissolved in water. Also, different types of gases will have different solubilities under the same conditions.

Table 1 below shows the solubility of CO₂ in water at various temperatures under 1.0 atm pressure. In accordance with Henry's Law, the solubility of CO₂ in water is inversely proportional to the temperature. Thus, a desired amount of CO₂ can be infused into water by controlling the temperature and the surface partial pressure of CO₂. For instance, according to the table, at 4° C. under 1 atm pressure, 147.3% (vol/vol) of CO₂ gas can be infused into water; while at 37° C., 57.0% (vol/vol) of CO₂ gas can be infused into water. Therefore, when the gas-containing beverage that has been kept at 4° C. is poured into the subject's mouth (at body temperature), about 90% (vol/vol) of the CO₂ gas will be released as the temperature of the beverage increases. The rate at which bubbles are generated in the mouth will depend on the rate and amount of temperature increase of the beverage, which will depend on the volume of the beverage taken into the mouth.

TABLE 1
Aqueous solubility of CO₂ at 1.0 atm partial pressure.
Column A, temperature; Column B, dissolved CO₂ volume per
volume H₂O; Column C, grams CO₂ per 100 ml H₂O;

| A | B | C |
|---|---|---|
| 0° C. | 1.713 | 0.3346 |
| 1° C. | 1.646 | 0.3213 |
| 2° C. | 1.584 | 0.3091 |
| 3° C. | 1.527 | 0.2978 |
| 4° C. | 1.473 | 0.2871 |
| 5° C. | 1.424 | 0.2774 |
| 6° C. | 1.377 | 0.2681 |
| 7° C. | 1.331 | 0.2599 |
| 8° C. | 1.282 | 0.2492 |
| 9° C. | 1.237 | 0.2403 |
| 10° C. | 1.194 | 0.2318 |
| 11° C. | 1.154 | 0.2239 |
| 12° C. | 1.117 | 0.2165 |
| 13° C. | 1.083 | 0.2098 |
| 14° C. | 1.050 | 0.2032 |
| 15° C. | 0.988 | 0.1970 |
| 16° C. | 0.985 | 0.1903 |
| 17° C. | 0.956 | 0.1845 |
| 18° C. | 0.928 | 0.1789 |
| 19° C. | 0.902 | 0.1737 |
| 20° C. | 0.878 | 0.1688 |
| 21° C. | 0.854 | 0.1640 |
| 22° C. | 0.829 | 0.1590 |
| 23° C. | 0.804 | 0.1540 |
| 24° C. | 0.781 | 0.1493 |
| 25° C. | 0.759 | 0.1449 |
| 26° C. | 0.738 | 0.1406 |
| 27° C. | 0.718 | 0.1366 |
| 28° C. | 0.699 | 0.1327 |
| 29° C. | 0.682 | 0.1292 |
| 30° C. | 0.655 | 0.1257 |
| 35° C. | 0.592 | 0.1105 |
| 40° C. | 0.530 | 0.0973 |
| 45° C. | 0.479 | 0.0860 |
| 50° C. | 0.436 | 0.0761 |
| 60° C. | 0.359 | 0.0576 |

In some embodiments, the volume of gas in the aqueous liquid at 1.0 atm pressure is at least 120% of the volume of the aqueous liquid. Characteristics of the pill will affect the implementation of this invention. The density of the pill will affect swallowing of the pill. A lower density pill will float easier, thereby making the pill easier to swallow. Also, a smaller pill can be floated with fewer and smaller bubbles. A larger pill will require more bubbles of larger size to float the pill. This invention could also facilitate swallowing multiple pills (e.g. 8 medium-size pills) simultaneously.

Examples of pills include tablets, capsules, softgels, and spansules. The medicinal pill may contain any of various types of medicinal substances, such as prescription drugs, over-the-counter drugs, nutritional supplements, etc. The pill could have any conventional shape and dimensions.

In some embodiments, the pill is a capsule. The capsule could be any conventional size. For example, the capsule could have a length in the range of 1.0-2.8 cm or an external diameter in the range of 4.0-12.0 mm. In some embodiments, the pill is a tablet. The tablet could be round and have any conventional size. For example, the tablet could have a diameter of 3.0-25 mm. In some cases, the tablet has an elongate shape with a length of 1.0-3.5 cm or a width of 2.0-6.0 mm.

This method of ingesting a pill can also be used for training someone on how to swallow a pill. This training may be particularly suitable for young children (e.g. age 9 years or younger) in swallowing a pill. This training could help children to overcome the fear of swallowing pills and teach the necessary skills to effectively swallow medicinal pills.

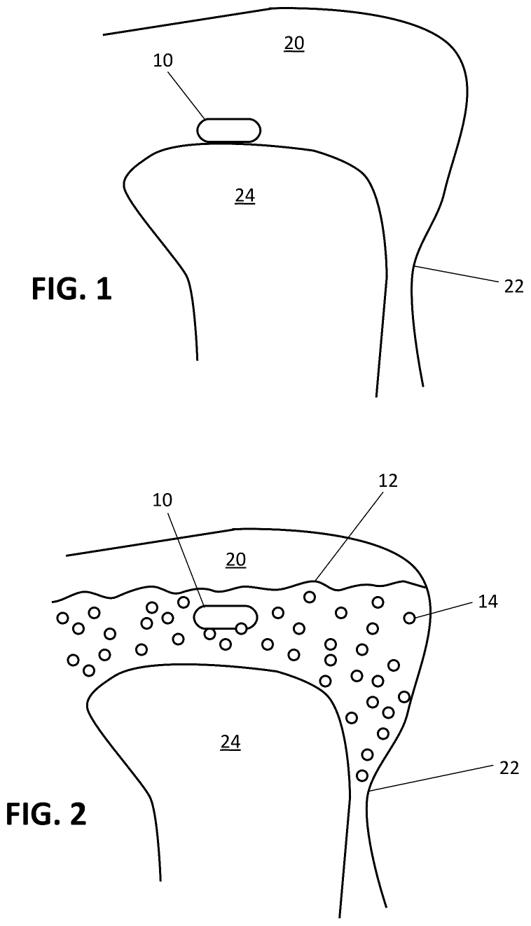

FIGS. 1-3 show an example of how the invention could be implemented. FIG. 1 shows the inside of a subject's mouth 20, along with the subject's tongue 24 and throat 22. A pill 10 is placed on the subject's tongue 24. When pill 10 is placed on tongue 24, the body senses the solid object on tongue 24 and this prevents triggering of the swallowing mechanism. FIG. 2 shows the inside of the subject's mouth 20 after some of the gas-containing beverage 12 is poured into the subject's mouth 20. Bubbles 14 form within the aqueous liquid of beverage 12. These bubbles 14 work to detach pill 10 off tongue 24 and lift it up so that it floats within beverage 12. When pill 10 is lifted off tongue 24, the subject loses sensation of there being pill 10 in the subject's mouth 20. The subject feels like they are just drinking beverage 12. This helps in overcoming the subject's aversion to swallowing pill 10.

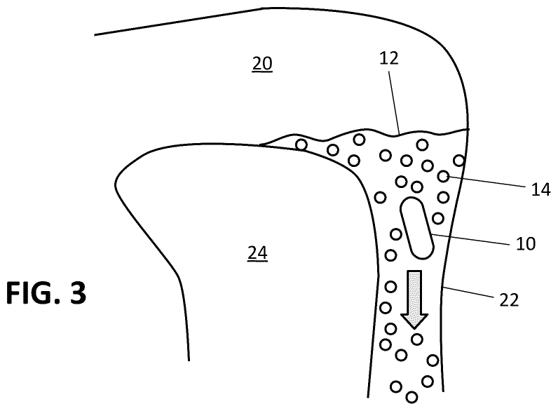

As shown in FIG. 3, as the subject swallows beverage 12 along with pill 10, they pass down the subject's throat 22 (in the direction of the shaded arrow). Bubbles 14 could also serve as a sensory distraction that helps with swallowing. The sensation of bubbles 14 in the mouth 20 may deceive the subject's mind into thinking that there is no pill 10 in the mouth 20.

The foregoing description and examples merely illustrate the invention and are not intended to be limiting. Each of the disclosed aspects and embodiments of the invention may be considered individually or in combination with other aspects, embodiments, and variations of the invention. Also, unless otherwise specified, the steps of the methods of the invention are not limited to any particular order of performance. Persons skilled in the art may perceive modifications to these embodiments that incorporate the spirit and substance of the invention. Such modifications are within the scope of the invention.

Any use of the word “or” herein is intended to be inclusive and is equivalent to the expression “and/or,” unless the context clearly indicates otherwise. As such, for example, the expression “A or B” means A, or B, or both A and B. Similarly, for example, the expression “A, B, or C” means A, or B, or C, or any combination thereof.

1. A method for ingesting a medicinal pill by mouth, comprising:
having a beverage comprising an aqueous liquid and a gas dissolved in the aqueous liquid;
placing a pill on a tongue in the mouth;
pouring the beverage into the mouth, wherein the beverage generates gas bubbles;
retaining the beverage in the mouth until the gas bubbles lift the pill off the tongue;
swallowing the beverage together with the pill.

2. The method of claim 1, wherein the gas is CO₂.

3. The method of claim 1, wherein the gas is O₂, CO₂, N₂, H₂, He, or air.

4. The method of claim 1, wherein the pill is a tablet or capsule.

5. The method of claim 1, wherein the beverage is stored under pressure inside a sealed container.

6. The method of claim 1, wherein the beverage is stored at a temperature in the range of 0-10° C.

7. The method of claim 1, wherein the beverage is made by infusing the gas into the aqueous liquid under pressure.

8. The method of claim 1, wherein the method is used in helping a subject perform pill swallowing.

9. The method of claim 1, wherein the method is used in training a subject on pill swallowing.

10. The method of claim 9, wherein the subject is a child of age 9 years or younger.

11. The method of claim 1, wherein the beverage further comprises a sweetener.

12. The method of claim 1, wherein the volume of gas in the aqueous liquid at 1.0 atm pressure is at least 120% of the volume of the aqueous liquid.

13. The method of claim 4, wherein the pill is a capsule.

14. The method of claim 13, wherein the capsule has a length of 1.0-2.8 cm.

15. The method of claim 13, wherein the capsule has an external diameter of 4.0-12.0 mm.

16. The method of claim 4, wherein the pill is a tablet.

17. The method of claim 16, wherein the tablet has a round shape with a diameter of 3.0-25 mm.

18. The method of claim 16, wherein the tablet has an elongate shape.

19. The method of claim 18, wherein the length of the tablet is 1.0-3.5 cm.

20. The method of claim 19, wherein the width of the tablet is 2.0-6.0 mm.
